(19) United States
(12) Patent Application Publication
(10) Pub. No.: US 2026/0356093 A1
(43) Pub. Date: Nov. 12, 2026

(54) INKJET-TYPE IMAGE FORMING APPARATUS

(71) Applicant: KYOCERA Document Solutions Inc., Osaka (JP)

(72) Inventors: Takeshi WATANABE, Osaka (JP); Nobuyuki HAYASHI, Osaka (JP); Kenichiro KAWASAKI, Osaka (JP); Akihisa MORI, Osaka (JP); Sumire NAGOYA, Osaka (JP)

(73) Assignee: KYOCERA Document Solutions Inc., Osaka (JP)

(21) Appl. No.: 19/670,240

(22) Filed: May 7, 2026

(30) Foreign Application Priority Data
May 9, 2025 (JP) 2025-079058

(51) Int. Cl. B41J 2/045; B41J 2/165

(52) U.S. Cl. CPC B41J 2/04596; B41J 2/04553; B41J 2/04563; B41J 2/04573; B41J 2/04581; B41J 2/16505; B41P 2235/20

(57) ABSTRACT

A controller causes a piezoelectric element to vibrate at a predetermined intensity at which ink droplets are not ejected from nozzles, when a temperature of a nozzle surface is lower than a temperature of a humidifying fluid at the time of supplying power to an image forming apparatus, returning from a sleep mode, or starting printing of an image forming device while the nozzle surface is covered by a cap.

### INCORPORATION BY REFERENCE

This application claims priority to Japanese Patent Application No. 2025-079058 filed on May 9, 2025, the entire contents of which are incorporated by reference herein.

### BACKGROUND

The present disclosure relates to an image forming apparatus performing printing on paper by ejecting ink.

In inkjet-type image forming apparatuses that perform printing by ejecting ink, when ink clogging occurs due to solidification at ejection ports of nozzles caused by drying of the ink, the ink may not be ejected normally and an image may not be properly printed.

In order to solve this problem, a method has generally been provided in which a nozzle surface is repeatedly wiped with a wiper to remove condensation components adhered to the nozzle surface when a difference between a platen temperature T and an ambient air temperature t around a head reaches or exceeds a predetermined value. In addition, as another technique that is generally performed, a method for preventing condensation is provided in which a piezoelectric element is heated using a heating device. In addition, as yet another generally performed technique, a method is provided for preventing condensation by heating a piezoelectric element through vibration without using a heating device.

### SUMMARY

According to an aspect of the present disclosure, a technology further improving the foregoing technology is proposed.

An image forming apparatus according to an aspect of the present disclosure includes a recording head device, a control device, a first detector, a cap, a humidifying device, a second detector, and an image forming device. The recording head device has a nozzle surface on which a plurality of nozzles for ejecting ink open and a piezoelectric element, and ejects ink droplets from the nozzles when the piezoelectric element vibrates. The control device includes a processor and functions as a controller when the processor executes a control program. The controller controls driving of the piezoelectric element. The first detector detects a temperature of the nozzle surface. The cap is detachably attached to the nozzle surface and covers the nozzle surface. The humidifying device humidifies inside the cap using a humidifying fluid that is a humidifying liquid or a humidifying gas. The second detector detects a temperature of the humidifying fluid. The image forming device has the recording head device. The controller causes the piezoelectric element to vibrate at a predetermined intensity at which the ink droplets are not ejected from the nozzles, when the temperature of the nozzle surface is lower than the temperature of the humidifying fluid at the time of supplying power to the image forming apparatus, returning from a sleep mode, or starting printing of the image forming device while the nozzle surface is covered by the cap.

Moreover, an image forming apparatus according to another aspect of the present disclosure includes a recording head device, a control device, a first detector, a cap, a humidifying device, and an image forming device. The recording head device has a nozzle surface on which a plurality of nozzles for ejecting ink open and a piezoelectric element, and ejects ink droplets from the nozzles when the piezoelectric element vibrates. The control device includes a processor and functions as a controller when the processor executes a control program. The controller controls driving of the piezoelectric element. The first detector detects a temperature of the nozzle surface. The cap is detachably attached to the nozzle surface and covers the nozzle surface. The humidifying device humidifies inside the cap using a humidifying fluid that is a humidifying liquid or a humidifying gas. The image forming device has the recording head device. The controller causes the piezoelectric element to vibrate at a predetermined intensity at which ink droplets are not ejected from the nozzles, when a current temperature that is a temperature of the nozzle surface at the time of supplying power to the image forming apparatus, returning from a sleep mode, or starting printing of the image forming device while the nozzle surface is covered by the cap is lower, by a predetermined temperature amount or greater, than a previous temperature that is a temperature of the nozzle surface at a previous time of supplying power to the image forming apparatus, returning from the sleep mode, or starting printing of the image forming device while the nozzle surface is covered by the cap.

### BRIEF DESCRIPTION OF THE DRAWINGS

FIG. 1 is a cross-sectional front view showing an image forming apparatus.

FIG. 2 is a cross-sectional view showing a recording head device and a maintenance device.

FIG. 3 is a plan view of a bottom surface of the recording head device.

FIG. 4 is a cross-sectional view showing a state when a cap of a cap device is mounted on a nozzle surface.

FIG. 5 is a functional block diagram showing a main internal configuration of the image forming apparatus.

FIG. 6 is a flowchart showing a flow of a condensation prevention operation of the recording head device according to a first embodiment.

FIG. 7 is a graph showing a relationship between a vibration time, when a piezoelectric element is vibrated slightly to an extent that ink droplets are not ejected from nozzles, and a temperature change on the nozzle surface.

FIG. 8 is a flowchart showing a flow of a condensation prevention operation of the recording head device according to a second embodiment.

### DETAILED DESCRIPTION

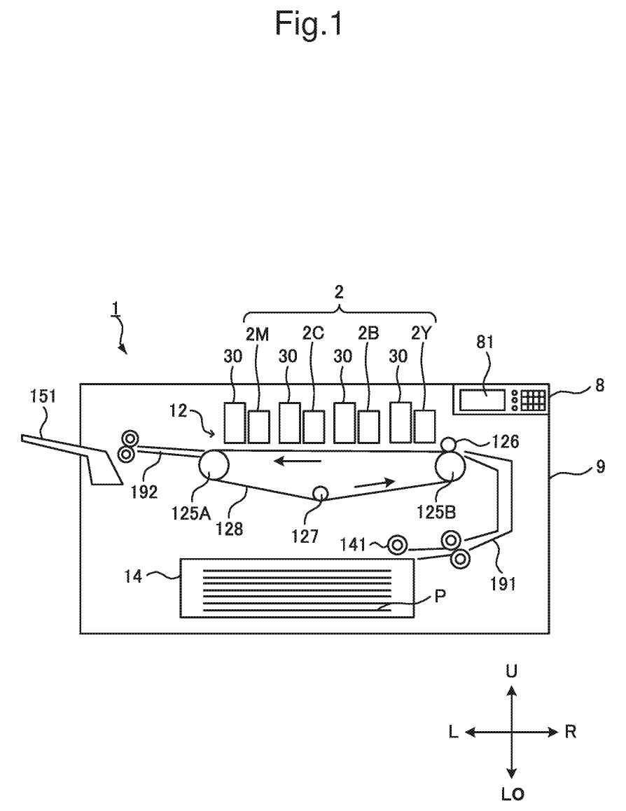

Hereinafter, an image forming apparatus according to an embodiment of the present disclosure will be described with reference to the drawings. FIG. 1 is a cross-sectional front view showing an image forming apparatus according to the embodiment of the present disclosure. An image forming apparatus 1 performs printing by ejecting ink and may be an image forming apparatus having a single function, such as a copy machine, a printer, or a facsimile machine, or a multifunction peripheral provided with a plurality of functions such as a copying function, a printing function, a scanner function, and a facsimile function. In the present embodiment, a printer will be described as an example. In addition, a color image forming apparatus will be described below, but a monochrome apparatus may be adopted.

In addition, in the following description, the near side of the sheet in the drawings refers to a front side of the image forming apparatus 1, and left and right directions will be described based on directions as viewed from the image forming apparatus 1. In each drawing, “U” indicates upward, “Lo” indicates downward, “L” indicates leftward, “R” indicates rightward, “F” indicates forward, and “Re” indicates rearward.

The image forming apparatus 1 includes an operation device 8, an image forming device 12, a paper feeding tray 14, and the like in an apparatus main body 9. For example, the operation device 8 includes a menu key for calling up a menu, a determination key for performing a confirmation operation of various operations and settings, a start key, and the like. A display device 81 is a liquid crystal display (LCD), an organic EL (OLED: organic light-emitting diode) display, or the like, and displays messages, operation screens, and the like for a user.

When the image forming apparatus 1 performs a printing operation, the image forming device 12 performs printing by ejecting ink onto a sheet of paper P fed from the paper feeding tray 14 on the basis of image data or the like transmitted from an external apparatus. A paper feeding roller 141 is provided above the paper feeding tray 14 so that the paper P accommodated in the paper feeding tray 14 is transported toward a transport path 191 by the paper feeding roller 141.

The image forming device 12 prints images or characters on the paper P, and includes a drive roller 125A, a driven roller 125B, an adsorption roller 126, a tension roller 127, a transport belt 128, recording head devices 2, and the like.

The recording head devices 2 include recording head devices 2B, 2C, 2M, and 2Y corresponding to four colors: black, cyan, magenta, and yellow. The recording head devices 2 form images or characters by ejecting ink droplets toward the paper P. The printed paper P is transported to a discharge path 192 and discharged to a discharge tray 151. Maintenance devices 30 are disposed adjacent to the respective recording head devices 2. Each of the maintenance devices 30 has a cap covering a nozzle surface of the recording head device 2, a wiper for wiping the nozzle surface, and the like.

The transport belt 128 is an endless belt looped around the drive roller 125A, the driven roller 125B, and the tension roller 127. The drive roller 125A is a roller rotationally driven counterclockwise by a motor (not shown). When the drive roller 125A is rotationally driven, the transport belt 128 travels counterclockwise (in a direction indicated by arrows in the drawing), and the driven roller 125B and the tension roller 127 are driven to rotate counterclockwise.

The tension roller 127 is a roller maintaining a tension state of the transport belt 128, and the adsorption roller 126 causes the transport belt 128 to electrostatically adsorb the paper P by charging the transport belt 128.

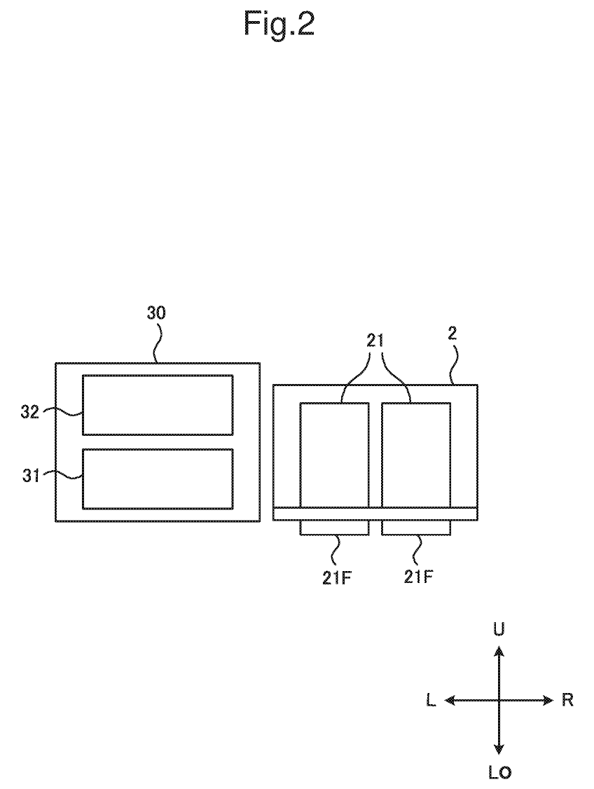

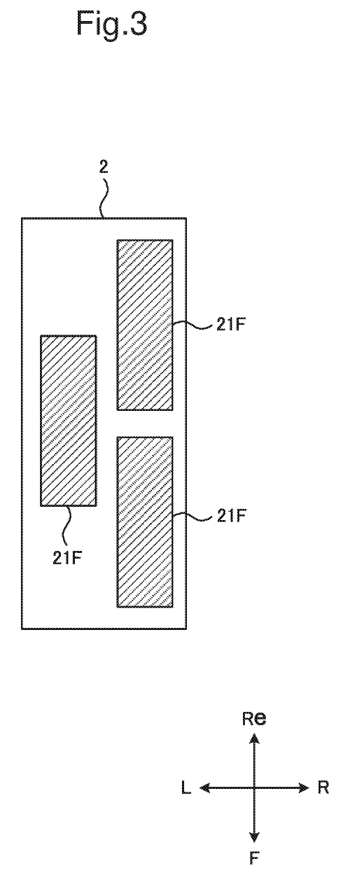

FIG. 2 is a cross-sectional view showing the recording head device 2 and the maintenance device 30. The recording head device 2 has a plurality of inkjet heads 21. FIG. 3 is a plan view of a bottom surface of the recording head device 2 (a view seen from below when the recording head device 2 is installed in the image forming apparatus 1). As shown in FIG. 3, nozzle surfaces 21F, which constitute the bottom surface of the recording head device 2, are disposed on bottom surfaces of the inkjet heads 21 in a staggered manner.

The maintenance device 30 is provided adjacent to each of the recording head devices 2 for each recording head device 2. The maintenance device 30 includes a cap device 31 having a cap 311 mounted on each nozzle surface 21F of the recording head device 2, and a wiper device 32 performing a wiping operation on the nozzle surface 21F to wipe off residual ink. The maintenance device 30 includes a mechanism for causing the cap device 31 to slide in a lateral direction (not shown), and a mechanism for causing the wiper device 32 to slide in the lateral direction (not shown).

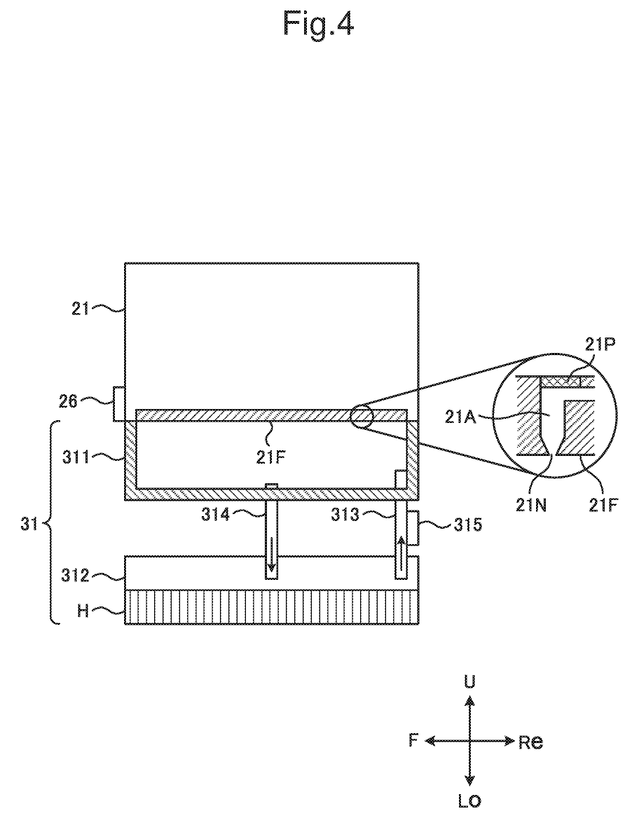

FIG. 4 is a cross-sectional view showing a state when the cap 311 of the cap device 31 is mounted on the nozzle surface 21F. A first detector (nozzle surface temperature detector) 26 for detecting the temperature of the nozzle surface is disposed near the nozzle surface 21F of the inkjet head 21. For example, the first detector 26 is a sensor such as a thermistor whose electrical resistance changes in accordance with a temperature change, and may be embedded in the inkjet head 21 near the nozzle surface 21F.

The nozzle surface 21F has a plurality of nozzles 21N. Each nozzle 21N includes an ink flow channel 21A connected to an ink accommodation device (not shown), and a piezoelectric element 21P. The piezoelectric element 21P vibrates in response to a voltage applied under control of a controller 111 which will be described below, thereby changing the volume of the ink flow channel 21A. Ink droplets are ejected from the nozzle 21N due to the volume change.

The cap device 31 includes the cap 311, a humidifying liquid tank 312 storing a humidifying liquid H (an example of a humidifying device according to the present disclosure), a first pipe 313, a second pipe 314, and a second detector (humidifying fluid temperature detector) 315. For example, the second detector 315 is a sensor such as a thermistor whose electrical resistance changes in accordance with a temperature change. The air inside the humidifying liquid tank 312 has a higher humidity than the air outside the humidifying liquid tank 312 due to the humidifying liquid H. Further, when the cap 311 is mounted on the nozzle surface 21F, the air inside the humidifying liquid tank 312 is sent into the cap 311 through the first pipe 313. As a result, the inside of the cap 311 is humidified, and drying of the nozzle surface 21F can be prevented.

Further, the air inside the cap 311 returns to the humidifying liquid tank 312 via the second pipe 314. The air that has returned to humidifying liquid tank 312 comes into contact with the humidifying liquid H, and its humidity increases again.

In the foregoing description, the air humidified by the humidifying liquid H is sent to the cap 311 from the humidifying liquid tank 312, but the humidifying liquid H may be directly sent. Hereinafter, the air sent to the cap 311 from the humidifying liquid tank 312 is referred to as a humidifying fluid.

When the temperature at an installation location of the image forming apparatus 1 is low (during winter season, or the like), the temperature of the metal nozzle surface 21F drops sufficiently. During such a season, when power is supplied to the image forming apparatus 1, and when the cap 311 is mounted on the nozzle surface 21F, if the humidifying fluid is sent to the cap 311 from the humidifying liquid tank 312, the temperature of the nozzle surface 21F may be lower than the temperature of the humidifying fluid. In this case, condensation may occur on the nozzle surface 21F so that ink droplets may not be ejected normally from the nozzle 21N due to a difference between the humidifying fluid and the temperature of the nozzle surface 21F. When ink droplets are not ejected normally, printing defects occur.

Hence, at a predetermined timing (when power is supplied to the image forming apparatus 1, when it returns from a sleep mode (power-saving mode), or when the image forming device 12 starts printing), and when the cap 311 is mounted on the nozzle surface 21F, the first detector 26 detects a temperature Ht on the nozzle surface 21F, and the second detector 315 detects a temperature Lt of the humidifying fluid. When the temperature Ht is lower than the temperature Lt (0>Ht‒Lt), the temperature of the nozzle surface 21F is raised by causing the piezoelectric element 21P to vibrate slightly to an extent that ink droplets are not ejected from the nozzle 21N. By increasing the temperature of the nozzle surface 21F, the temperature difference with respect to the humidifying fluid can be reduced, and condensation on the nozzle surface 21F can be prevented.

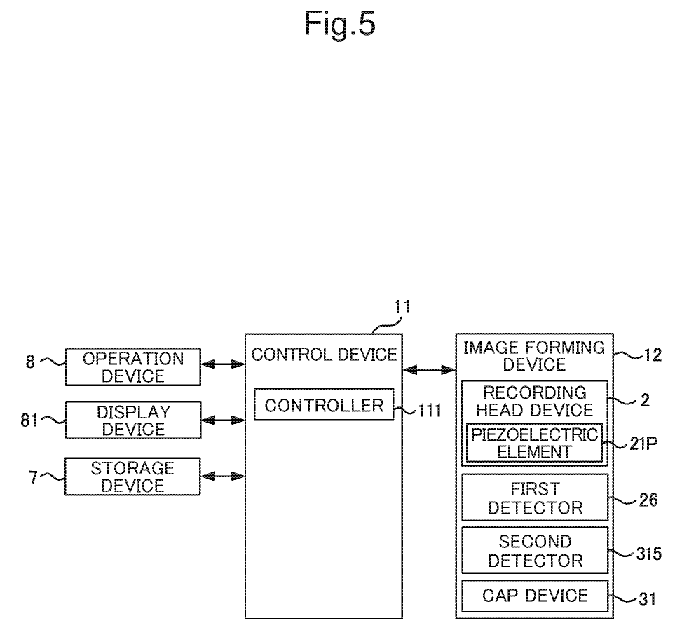

FIG. 5 is a functional block diagram showing a main internal configuration of the image forming apparatus 1. The same reference signs are applied to the constituent elements described using FIGS. 1-4, and description thereof is omitted. The image forming apparatus 1 includes a control device 11, the operation device 8, the display device 81, a storage device 7, and the image forming device 12.

The storage device 7 is a large-capacity storage apparatus such as a solid state drive (SSD) or a hard disk drive (HDD) storing various programs, data tables, and the like, and it stores data and programs necessary for operation of the image forming apparatus 1.

The control device 11 is constituted by a processor, a random access memory (RAM), a read only memory (ROM), and the like. The processor is a central processing unit (CPU), a micro processing unit (MPU), an application specific integrated circuit (ASIC), or the like. This control device 11 functions as the controller 111 by the processor executing the control program stored in the ROM or the like. Each of the foregoing parts of the control device 11 may be configured by a hardware circuit without depending on operation based on the control program.

The controller 111 controls overall operation of the image forming apparatus 1. Moreover, the controller 111 controls driving of the piezoelectric element 21P. That is, the piezoelectric element 21P vibrates under drive control of the controller 111, thereby causing ink droplets to be ejected from the nozzle 21N.

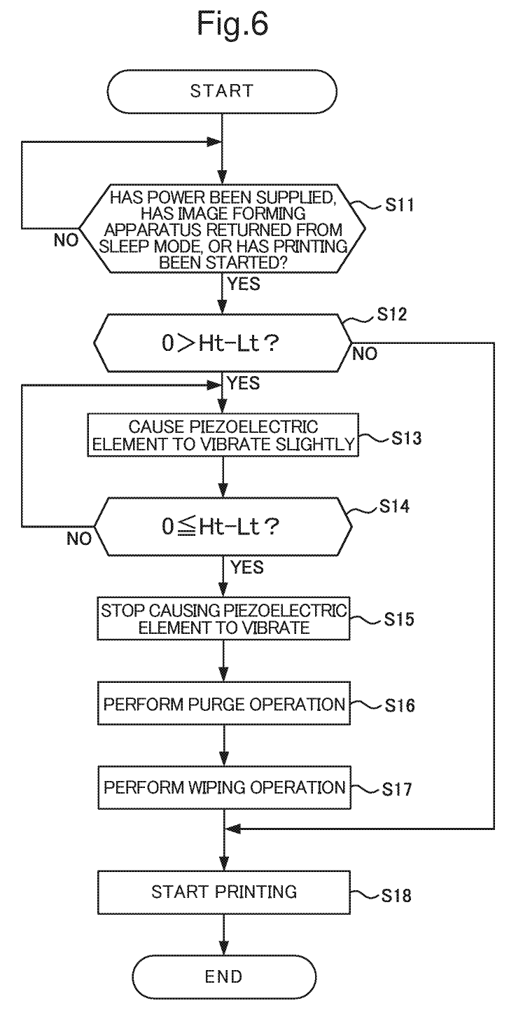

FIG. 6 is a flowchart showing a flow of a condensation prevention operation of the recording head device 2 according to a first embodiment. When the nozzle surface 21F is mounted on the cap 311, if the controller 111 detects that power has been supplied to the image forming apparatus 1, the image forming apparatus 1 has returned from the sleep mode, or the image forming device 12 has started printing (S11; YES), the controller 111 acquires the temperature Ht on the nozzle surface 21F from the first detector 26 and the temperature Lt of the humidifying fluid from the second detector 315, and calculates a difference between the temperature Ht and the temperature Lt (S12). Here, the time when returning from the sleep mode refers to a time when the image forming apparatus 1 is temporarily stopped and returns from a power-saving state in which power consumption is suppressed to a normal state.

When the temperature Ht is equal to or higher than the temperature Lt (S12; NO), the controller 111 proceeds to the processing S18, and the controller 111 causes the image forming device 12 to start printing (S18) and ends the processing. When the temperature Ht is lower than the temperature Lt (S12; YES), that is, when 0>Ht‒Lt is satisfied, the controller 111 causes the piezoelectric element 21P to vibrate slightly (S13). At this time, the controller 111 causes a drive device (not shown) to drive operation of the piezoelectric element 21P with a predetermined vibration intensity to an extent that ink droplets are not ejected from the nozzle 21N. For example, the controller 111 stores the drive voltage for vibrating the piezoelectric element 21P at the predetermined intensity, and outputs the drive voltage to the drive device.

The controller 111 acquires the temperature Ht on the nozzle surface 21F from the first detector 26 and the temperature Lt of the humidifying fluid from the second detector 315 again, and calculates a difference between the temperature Ht and the temperature Lt which have been acquired (S14). When the temperature Ht is lower than the temperature Lt (S14; NO), the controller 111 continues to cause the piezoelectric element 21P to vibrate slightly (S13). Meanwhile, when the temperature Ht is equal to or higher than the temperature Lt (S14; YES), that is, when 0≤Ht‒Lt is satisfied, the controller 111 stops causing the piezoelectric element 21P to vibrate slightly (S15).

Further, the controller 111 controls the recording head device 2 to perform a purge operation of ejecting ink inside the nozzle 21N into the cap 311 (S16). Subsequently, the controller 111 controls the wiper device 32 to clean the nozzle surface 21F (S17).

Specifically, the controller 111 controls a lifting/lowering mechanism (not shown) of the recording head device 2 to raise the recording head device 2 to a predetermined wiping position. Further, the controller 111 controls a slide mechanism (not shown) of the wiper device 32 to move the wiper device 32 below the nozzle surface 21F from a retreat position (position in FIG. 2) and cause a wiping blade (not shown) of the wiper device 32 to slide on the nozzle surface 21F, thereby wiping ink on the nozzle surface 21F. Thereafter, the controller 111 controls the slide mechanism (not shown) of the wiper device 32 again to move the wiper device 32 to the retreat position. A known technology is used for the foregoing purge operation and wiping operation, and detailed description thereof is omitted.

Thereafter, the controller 111 causes the image forming device 12 to start printing (S18), and ends the processing.

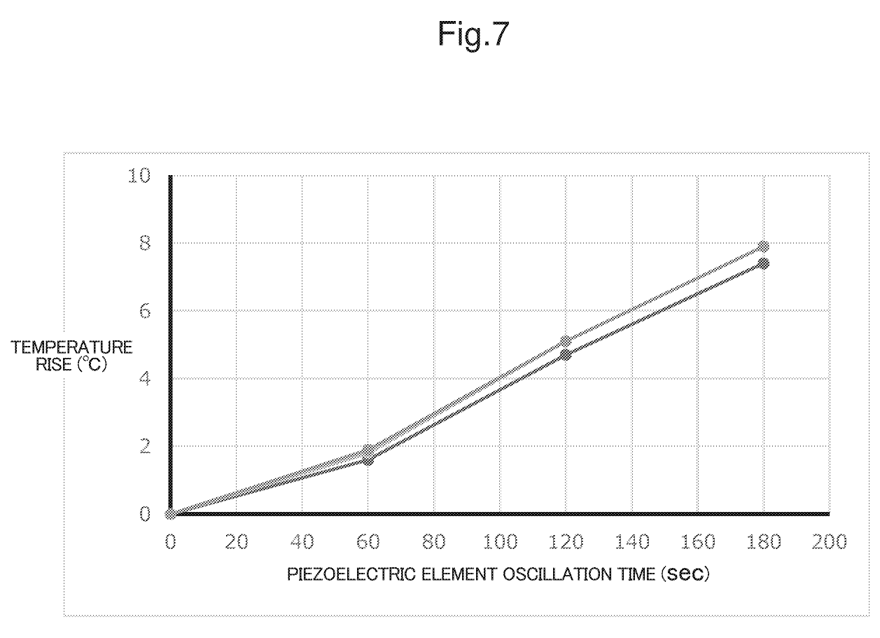

FIG. 7 is a graph showing a relationship between a vibration time, when the piezoelectric element 21P is vibrated slightly to an extent that ink droplets are not ejected from the nozzle 21N (piezoelectric element oscillation time), and a temperature change on the nozzle surface 21F (temperature rise). The controller 111 may store, in advance, the relationship between the slight vibration time of the piezoelectric element 21P and a temperature change on the nozzle surface 21F shown in FIG. 7, and determine the slight vibration time of the piezoelectric element 21P from the temperature difference between the temperature Ht and the temperature Lt calculated in the processing S12 and the processing S14 shown in FIG. 6.

According to the graph shown in FIG. 7, when the piezoelectric element 21P vibrates for 60 seconds, the temperature of the nozzle surface 21F rises by approximately 2° C, and when it vibrates for 120 seconds, the temperature rises by approximately 5° C. For example, during winter in Japan, the temperature Ht on the nozzle surface 21F is often lower than the temperature Lt of the humidifying fluid by 2° C to 3° C. In this case, the controller 111 causes the piezoelectric element 21P to vibrate slightly for approximately 1 minute to 1 minute and 30 seconds. Consequently, the temperature difference between the temperature Ht on the nozzle surface 21F and the temperature Lt of the humidifying fluid is eliminated, and condensation on the nozzle surface 21F can be prevented.

In addition, in the processing S12 and the processing S14, it is judged whether or not the temperature Ht is lower than the temperature Lt based on the presence or absence of slight vibration of the piezoelectric element 21P, but condensation conditions on the nozzle surface 21F vary depending on the structure of the image forming apparatus 1, performance of a humidifying mechanism for humidifying the inside of the cap 311, and the like. Therefore, it is desirable that the temperature difference between the temperature Ht and the temperature Lt when the piezoelectric element 21P is vibrated slightly be changeable depending on the condensation conditions.

As described above, the controller 111 calculates the temperature difference between the temperature Ht on the nozzle surface 21F and the temperature Lt of the humidifying fluid, and when the temperature Ht on the nozzle surface 21F is lower than the temperature Lt of the humidifying fluid, the nozzle surface 21F is heated by causing the piezoelectric element 21P to vibrate slightly. Therefore, condensation on the nozzle surface 21F can be prevented. That is, ejection of ink droplets from the nozzle 21N can be made stable, and printing defects can be prevented.

In addition, since the controller 111 judges whether or not to cause the piezoelectric element 21P to vibrate slightly on the basis of the temperature difference between the nozzle surface 21F and the humidifying fluid, slight vibration can be performed at a timing when condensation is highly likely to occur on the nozzle surface 21F. In other words, since the controller 111 does not unnecessarily cause the piezoelectric element 21P to vibrate slightly, this makes the number of times of wiping operations of wiping the nozzle surface 21F reduced, and a service life of the wiping blade (not shown) can be extended.

Here, when the temperature of the nozzle surface 21F is lower than the previous temperature of the nozzle surface 21F at the time of supplying power to the image forming apparatus 1, returning from the sleep mode, or starting printing, temperature change in surrounding components is smaller than that on the metal nozzle surface 21F having high thermal conductivity, and there is a high likelihood of condensation on the nozzle surface 21F. Hence, regarding a second embodiment, a method for heating the nozzle surface 21F by the controller 111 causing the piezoelectric element 21P to vibrate slightly when the current temperature of the nozzle surface 21F at the time of supplying power to the image forming apparatus 1, returning from the sleep mode, or starting printing of the image forming device 12 is lower than the previous temperature of the nozzle surface 21F at the time of supplying power to the image forming apparatus 1, returning from the sleep mode, or starting printing of the image forming device 12 will be described as the second embodiment.

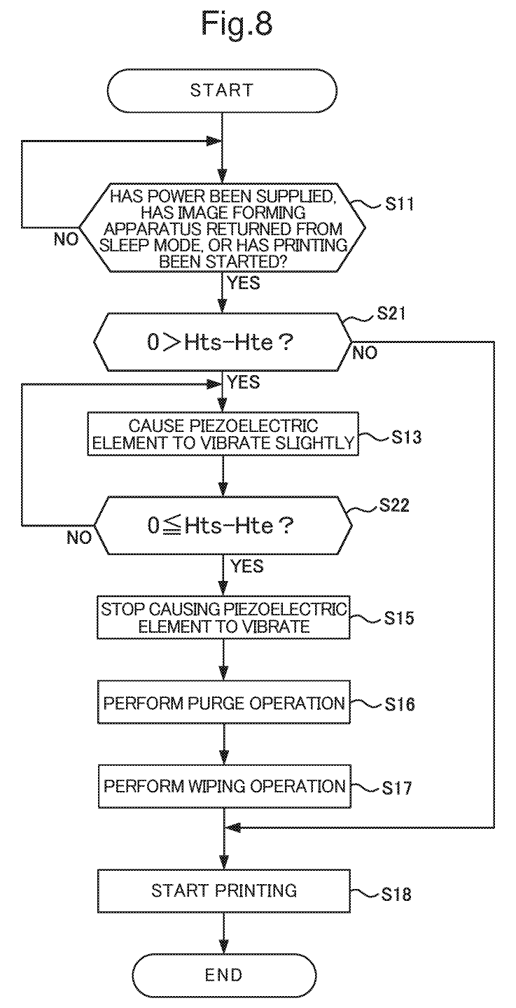

FIG. 8 is a flowchart showing a flow of a condensation prevention operation of the recording head device 2 according to the second embodiment. In the first embodiment, the same numbers are applied to the same processing as the processing described using FIG. 6, and the processing description thereof is simplified.

When the nozzle surface 21F is mounted on the cap 311, if the controller 111 detects that power has been supplied to the image forming apparatus 1, the image forming apparatus 1 has returned from the sleep mode, or the image forming device 12 has started printing (S11; YES), the controller 111 acquires a temperature Hts (an example of the current temperature) at this point of time on the nozzle surface 21F from the first detector 26, and calculates a difference with respect to a previous temperature Hte on the nozzle surface 21F at the time of supplying power to the image forming apparatus 1, returning from the sleep mode, or starting printing of the image forming device 12 (S21). The controller 111 stores the previous temperature Hte on the nozzle surface 21F at the time of supplying power to the image forming apparatus 1, returning from the sleep mode, or starting printing of the image forming device 12.

When the temperature Hts is equal to or higher than the temperature Hte (S21; NO), the controller 111 proceeds to the processing S18, and the controller 111 causes the image forming device 12 to start printing (S18). When the temperature Hte is lower than the temperature Hts (S21; YES), that is, when 0>Hts-Hte is satisfied, the controller 111 causes the piezoelectric element 21P to vibrate slightly (S13). At this time, the controller 111 controls driving of the drive device (not shown) with respect to the piezoelectric element 21P with a predetermined vibration intensity to an extent that ink droplets are not ejected from the nozzle 21N. For example, the controller 111 stores the drive voltage for vibrating the piezoelectric element 21P at the predetermined intensity, and outputs the drive voltage to the drive device.

The controller 111 acquires the temperature Hts on the nozzle surface 21F from the first detector 26 again, and calculates a difference between the acquired temperature Hts and the temperature Hte. That is, it is judged whether or not 0≤Hts-Hte is satisfied (S22). When the temperature Hts is lower than the temperature Hte (S22; NO), the controller 111 continues to cause the piezoelectric element 21P to vibrate slightly (S13). Meanwhile, when the temperature Hts is equal to or higher than the temperature Hte (S22; YES), the controller 111 stops causing the piezoelectric element 21P to vibrate slightly (S15).

Further, the controller 111 controls the recording head device 2 to perform a purge operation of ejecting ink inside the nozzle 21N into the cap 311 (S16). Subsequently, the controller 111 controls the wiper device 32 to clean the nozzle surface 21F (S17). Thereafter, the controller 111 causes the image forming device 12 to start printing (S18), and ends the processing.

Similarly to the first embodiment, in the second embodiment as well, the controller 111 may store, in advance, the relationship between the slight vibration time of the piezoelectric element 21P and a temperature change on the nozzle surface 21F shown in FIG. 7, and determine the vibration time of the piezoelectric element 21P from the temperature difference calculated in the processing S21 and the processing S22 shown in FIG. 8.

In addition, in the processing S21 and the processing S22, it is judged whether or not to cause the piezoelectric element 21P to vibrate slightly based on the time when the temperature Hts is lower than the temperature Hte (when 0>Hts‒Hte). However, condensation conditions on the nozzle surface 21F vary depending on the structure of the image forming apparatus 1, performance of the humidifying mechanism for humidifying the inside of the cap 311, and the like. Therefore, it is desirable that the temperature difference between the temperature Hts and the temperature Hte when the piezoelectric element 21P is vibrated slightly be changeable depending on the condensation conditions.

In addition, in circumstances in which condensation rarely occurs on the nozzle surface 21F due to the installation environment and the configuration of the image forming apparatus 1, season, or the like, frequently executed operation of causing the piezoelectric element 21P to vibrate slightly may lead to degradation or the like of productivity of the image forming apparatus 1. Hence, the controller 111 may cause the piezoelectric element 21P to vibrate slightly when the temperature Hts is lower than the temperature Hte by a range of 5° C or larger, for example. That is, in the processing S21 in FIG. 8, the controller 111 may cause the piezoelectric element 21P to vibrate slightly when the temperature Hts is lower than the temperature Hte by a range of 5° C or larger (‒5≥Hts‒Hte).

As described above, a nozzle surface temperature storage device 113 stores the previous temperature Hte on the nozzle surface 21F at the time of supplying power to the image forming apparatus 1, returning from the sleep mode, or starting printing, and when the current temperature Hts on the nozzle surface 21F at the time of supplying power, returning from the sleep mode, or starting printing is lower than the temperature Hte, the controller 111 causes the piezoelectric element 21P to vibrate slightly to heat the nozzle surface 21F. Therefore, condensation on the nozzle surface 21F can be prevented. In addition, as compared with the first embodiment, since the second embodiment does not require the second detector 315, cost reduction and structural simplification can be achieved.

Incidentally, in the foregoing method for removing condensation that has been generally performed, there is a likelihood that condensation will soon occur even after the nozzle surface is wiped unless the head temperature rises, resulting in deviation of ink droplets or occurrence of ejection defects. Moreover, there is a high likelihood of increase in the number of times of wiping the nozzle surface by the wiper, and increase in the number of times of replacement of the wiper.

In addition, in the case of another technique that has been generally performed other than that described above, a heating device for heating the piezoelectric element is separately required, which causes structural complexity and cost rise. Further, each of the foregoing techniques that have been generally performed is a technique performed when no cap is provided and the nozzle surface is in a sealed state by covering the nozzle surface while printing is not performed, and is not suitable as a measure for preventing condensation on a nozzle surface in a configuration including a cap.

The present embodiment has been made in such circumstances, and prevents condensation on a nozzle surface with a simple configuration in an image forming apparatus including a cap covering the nozzle surface.

In addition, the configurations and the processing described in the foregoing first embodiment using FIGS. 1-7, and the configurations and the processing described in the foregoing second embodiment using FIG. 8 are merely embodiments of the present disclosure, and the present disclosure is not intended to limit the configurations and the processing.

While the present disclosure has been described in detail with reference to the embodiments thereof, it would be apparent to those skilled in the art that the various changes and modifications may be made therein within the scope defined by the appended claims.

What is claimed is:

1. An image forming apparatus comprising:
a recording head device having a nozzle surface on which a plurality of nozzles for ejecting ink open and a piezoelectric element, and ejecting ink droplets from the nozzles when the piezoelectric element vibrates;
a control device including a processor and functioning as a controller for controlling driving of the piezoelectric element when the processor executes a control program;
a first detector for detecting a temperature of the nozzle surface;
a cap detachably attached to the nozzle surface and covering the nozzle surface;
a humidifying device for humidifying inside the cap using a humidifying fluid that is a humidifying liquid or a humidifying gas;
a second detector for detecting a temperature of the humidifying fluid; and
an image forming device having the recording head device,
wherein the controller causes the piezoelectric element to vibrate at a predetermined intensity at which the ink droplets are not ejected from the nozzles, when the temperature of the nozzle surface is lower than the temperature of the humidifying fluid at the time of supplying power to the image forming apparatus, returning from a sleep mode, or starting printing of the image forming device while the nozzle surface is covered by the cap.

2. The image forming apparatus according to claim 1,
wherein the controller determines a vibration time for vibrating the piezoelectric element in accordance with a difference between the temperature of the nozzle surface and the temperature of the humidifying fluid, and causes the piezoelectric element to vibrate at the predetermined intensity for the vibration time.

3. The image forming apparatus according to claim 2,
wherein the controller stores in advance a relationship between a time and a temperature change in the piezoelectric element when the piezoelectric element is vibrated at the predetermined intensity for the time, and determines the vibration time from the temperature difference.

4. An image forming apparatus comprising:
a recording head device having a nozzle surface on which a plurality of nozzles for ejecting ink open and a piezoelectric element, and ejecting ink droplets from the nozzles when the piezoelectric element vibrates;
a control device including a processor and functioning as a controller for controlling driving of the piezoelectric element when the processor executes a control program;
a first detector for detecting a temperature of the nozzle surface;
a cap detachably attached to the nozzle surface and covering the nozzle surface;
a humidifying device for humidifying inside the cap using a humidifying fluid that is a humidifying liquid or a humidifying gas; and
an image forming device having the recording head device,
wherein the controller causes the piezoelectric element to vibrate at a predetermined intensity at which ink droplets are not ejected from the nozzles, when a current temperature that is a temperature of the nozzle surface at the time of supplying power to the image forming apparatus, returning from a sleep mode, or starting printing of the image forming device while the nozzle surface is covered by the cap is lower, by a predetermined temperature amount or greater, than a previous temperature that is a temperature of the nozzle surface at a previous time of supplying power to the image forming apparatus, returning from the sleep mode, or starting printing of the image forming device while the nozzle surface is covered by the cap.

5. The image forming apparatus according to claim 4,
wherein the predetermined temperature amount is 5° C.

6. The image forming apparatus according to claim 4,
wherein the controller determines a vibration time for vibrating the piezoelectric element in accordance with a temperature difference between the previous temperature and the current temperature, and causes the piezoelectric element to vibrate at the predetermined intensity for the vibration time.

7. The image forming apparatus according to claim 1, further comprising:
a wiper device for performing a wiping operation on the nozzle surface,
wherein the controller controls the wiper device to perform the wiping operation on the nozzle surface.
